(19) United States
(12) Patent Application Publication
(10) Pub. No.: US 2012/0075262 A1
(43) Pub. Date: Mar. 29, 2012

(54) UNDER-RUN COMPENSATION CIRCUIT, METHOD THEREOF, AND APPARATUSES HAVING THE SAME

(76) Inventors: Kyoung Man Kim, Suwon-si (KR); Jong Ho Roh, Yongin-si (KR); Jae Sop Kong, Gwacheon-si (KR)

(21) Appl. No.: 13/206,704

(22) Filed: Aug. 10, 2011

(30) Foreign Application Priority Data
Sep. 28, 2010 (KR) 10-2010-0093544

(51) Int. Cl. G09G 5/00

(52) U.S. Cl. 345/204

(57) ABSTRACT

An under-run compensation circuit is provided. The under-run compensation circuit is configured to receive a clock signal, data, and an under-run detection signal that indicates whether or not an under-run is occurring. The under-run compensation circuit is further configured to output the clock signal and the data when receiving the under-run detection signal that indicates that an under-run is not occurring. The under-run compensation circuit is additionally configured to output the clock signal and dummy data when receiving the under- run detection signal that indicates that an under-run is occurring.

### CROSS-REFERENCE TO RELATED APPLICATIONS

This application claims priority under 35 U.S.C. §119(a) from Korean Patent Application No. 10-2010-0093544 filed on Sep. 28, 2010, the disclosure of which is hereby incorporated by reference in its entirety.

### BACKGROUND

Embodiments of the present disclosure relate to a display controller, and more particularly, to an under-run compensation circuit which may prevent image deterioration of a display device by compensating under-run of an input/output buffer, a method thereof, and apparatuses having the under-run compensation circuit.

In the recent mobile System on Chip (SoC) field, a demand for a high-performance SoC is getting higher. As development of a high-performance mobile SoC product gets accelerated, a demand for a high-definition display system is also increasing.

### SUMMARY

Some example embodiments provide an under-run compensation circuit which may prevent image deterioration of a display device even in an under-run state of an input/output buffer, an under-run compensation method, and apparatuses including the under-run compensation circuit.

According to one embodiment, an under-run compensation circuit is disclosed. The under-run compensation circuit is configured to receive a clock signal, data, and an under-run detection signal. The under-run detection signal indicates whether or not an under-run is occurring. The under-run compensation circuit is further configured to output the clock signal and the data when receiving the under-run detection signal that indicates that an under-run is not occurring. The under-run compensation circuit is additionally configured to output the clock signal and dummy data when receiving the under-run detection signal that indicates that an under-run is occurring.

In further embodiment, a display controller for preventing image deterioration of a display device is disclosed. The display controller includes an under-run compensation circuit. The under-run compensation circuit is configured to receive a clock signal and data. The under-run compensation circuit is further configured to output the clock signal and dummy data when receiving the under-run detection signal that indicates that an under-run is occurring.

In another embodiment, a method of preventing image deterioration of a display device is disclosed. The method includes receiving a clock signal, data, and an under-run detection signal that indicates whether or not an under-run is occurring. The method further includes outputting the clock signal and the data when receiving an under-run detection signal that indicates that an under-run is not occurring. The method additionally includes outputting the clock signal and dummy data when receiving an under-run detection signal that indicates that an under-run is occurring.

### BRIEF DESCRIPTION OF THE DRAWINGS

These and/or other aspects and advantages disclosed herein will become apparent and more readily appreciated from the following description of the embodiments, taken in conjunction with the accompanying drawings of which:

FIG. 1 shows a block diagram of a display system including a display controller for compensating under-run according to example embodiments;

FIG. 2 shows an internal block diagram of the display controller illustrated in FIG. 1, according to one exemplary embodiment;

FIG. 3 shows an internal block diagram of a FIFO circuit illustrated in FIG. 2, according to one exemplary embodiment;

FIG. 4 shows an internal block diagram of an under-run detection circuit illustrated in FIG. 2, according to one exemplary embodiment;

FIG. 5 shows an internal block diagram of an under-run compensation circuit illustrated in FIG. 2, according to one exemplary embodiment;

FIG. 6 shows a timing diagram for explaining an under-run compensation method according to example embodiments; and

FIG. 7 shows a flow chart illustrating a method of preventing image deterioration of a display device according to example embodiments.

### DETAILED DESCRIPTION OF THE EMBODIMENTS

Various example embodiments will be described more fully with reference to the accompanying drawings, in which some example embodiments are shown. The present invention may, however, be embodied in many different forms and should not be construed as limited to the embodiments set forth herein. Like reference numerals refer to like elements throughout this application.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

It will be understood that, although the terms first, second, third, etc. may be used herein to describe various elements, components, regions, layers and/or sections, these elements, components, regions, layers and/or sections should not be limited by these terms. Unless indicated otherwise, these terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments and is not intended to be limiting of the inventive concept. As used herein, the singular forms “a,” “an” and “the” are intended to include the plural forms as well, unless the context clearly indicates otherwise. It will be further understood that the terms such as “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

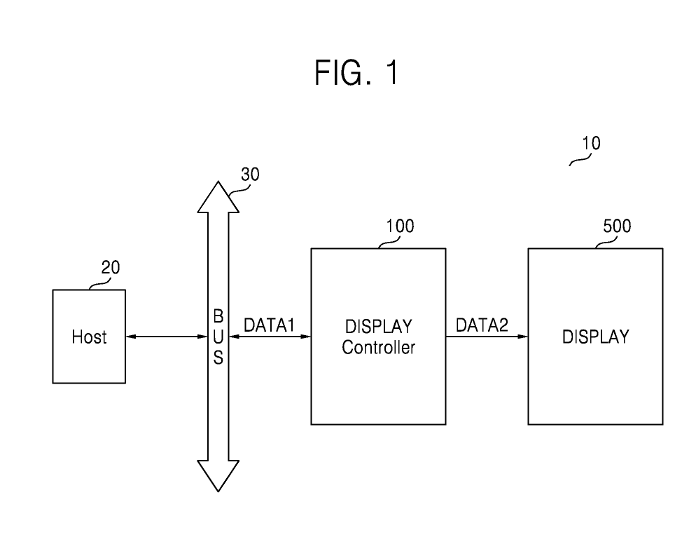

FIG. 1 shows a block diagram of a display system including a display controller for compensating an under-run according to example embodiments.

Display system 10 described herein may include, for example, a cell phone, PDA, camera, computer, etc.

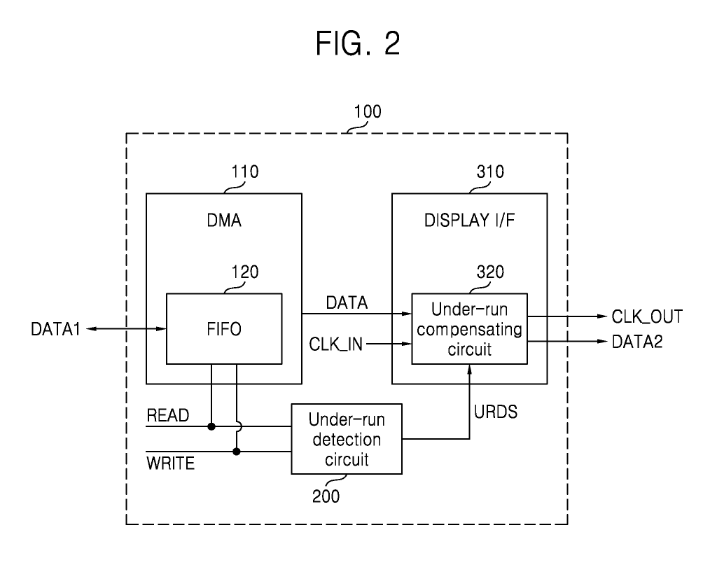

FIG. 2 shows an internal block diagram of the display controller illustrated in FIG. 1 according to one exemplary embodiment.

Referring to FIGS. 1 and 2, a display system 10 includes a display controller 100 connected to a system bus 30, and a display 500.

The display controller 100 includes a direct memory access (DMA) circuit 110, an under-run detection circuit 200 and a display interface 310.

The DMA circuit 110 stores data DATA1 received from a host 20 through the system bus 30 in a First-In-First-Out (FIFO) circuit 120.

The FIFO circuit 120 performs a function of a buffer storing temporarily data DATA1, and the DMA circuit 110 transmits the data (DATA=DATA1) to a display interface 310.

The under-run detection circuit 200 detects if the data DATA1 is stored in the FIFO circuit 120, generates an under-run detection signal URDS indicating that under run has occurred when the FIFO circuit 120 is empty, and transmits the under-run detection signal URDS to an under-run compensation circuit 320 inside a display interface 310.

Under-run in the present disclosure refers a state where the FIFO circuit 120 is not supplied with data DATA1 from the host 20 and it does not store the data DATA1, and is thus empty.

The display interface 310 includes the under-run compensation circuit 320 and the under-run compensation circuit 320 prevents image deterioration of the display system 10 by compensating under-run of the display system 10 in response to the under-run detection signal URDS output from the under-run detection circuit 200.

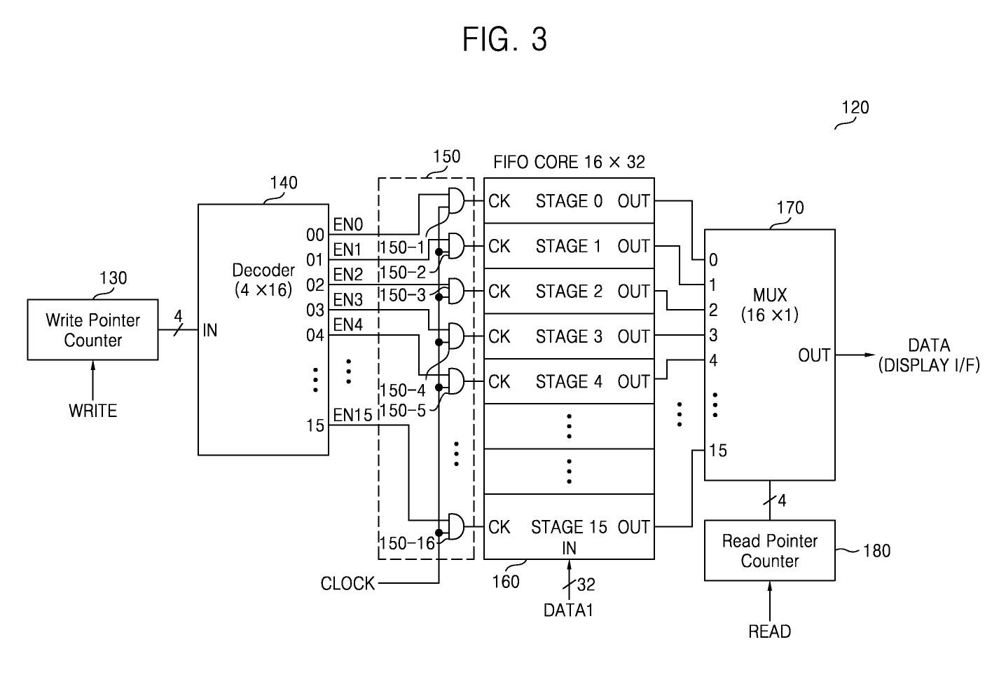

FIG. 3 shows an internal block diagram of a FIFO circuit illustrated in FIG. 2, according to one exemplary embodiment.

Referring to FIGS. 1 to 3, in one embodiment, the FIFO circuit 120 included in the DMA circuit 110 of FIG. 2 includes a write pointer counter 130, a decoder 140, a clock gating circuit 150, a FIFO core 160, a multiplexer 170 and a read pointer counter 180.

The FIFO core 160 may include, for example, a circuit including a plurality of flip-flops, that includes a plurality of stages STAGE0 to STAGE 15 (e.g., each stage including a set of flip-flops), and each of the plurality of stages STAGE0 to STAGE 15 (i.e., each set of flip-flops) may be composed of N-bits (N is a natural number, e.g., 32).

In FIG. 3, it is illustrated that the FIFO core 160 includes 16 stages STAGE0 to STAGE15 and each of the 16 stages STAGE0 to STAGE15 is composed of 32 bits, however, the present disclosure is not restricted to the number of stages included in the FIFO core 160, and the FIFO core 160 may be embodied various manners according to a design specification.

The write pointer counter 130 counts up a point in response to a write control signal WRITE.

For example, when a count value of the write pointer counter 130 is a decimal number 3, the write pointer counter 130 may increase the count value of the write pointer counter 130 to 4 in response to the write control signal WRITE.

In one embodiment, the decoder 140 decodes a count value (e.g., a 4-bit count value) output from the write pointer counter 130 and is configured to output a plurality of enable signals EN0 to EN15 for enabling each of 16 stages STAGE0 to STAGE15, which are embodied in the FIFO core 160, according to a decoding result.

In one embodiment, the clock gating circuit 150 includes a plurality of AND gates 150-1 to 150-16 each corresponding to one of the 16 stages STAGE0 to STAGE15 embodied in the FIFO core 160.

Each first input terminal of the plurality of AND gates 150-1 to 150-16 is connected to a respective one of a plurality of output terminals 00-15 of the decoder 140, and a clock signal CLOCK is supplied to each second input terminal of the plurality of AND gates 150-1 to 150-16.

Each of the 16 stages STAGE0 to STAGE15 receives and stores data DATA1, which is input from a system bus 30 through a data input terminal IN in response to each of a plurality of enable signals EN0 to EN15 output from each of the plurality of output terminals 00-15 of the decoder 140, and outputs stored data (DATA=DATA1) to a multiplexer 170 through an output terminal OUT.

In one embodiment, a clock signal CLOCK is supplied only to selected stages among the plurality of stages STAGE0 to STAGE15 according to an operation of the decoder 140.

In one embodiment, the read pointer counter 180 increase a count value in response to a read control signal READ. For example, when a count value of the read pointer counter 180 is a decimal number 1, the read pointer counter 180 increases the count value of the read pointer counter 180 to 2 in response to the read control signal READ.

The multiplexer 170 outputs data (DATA1=DATA) stored in one of the plurality of stages STAGE0 to STAGE15 included in the FIFO core 160 selectively in response to a 4-bit count value output from the read pointer counter 180. Data output from the multiplexer 170 is transmitted to a display interface 310 illustrated in FIG. 2.

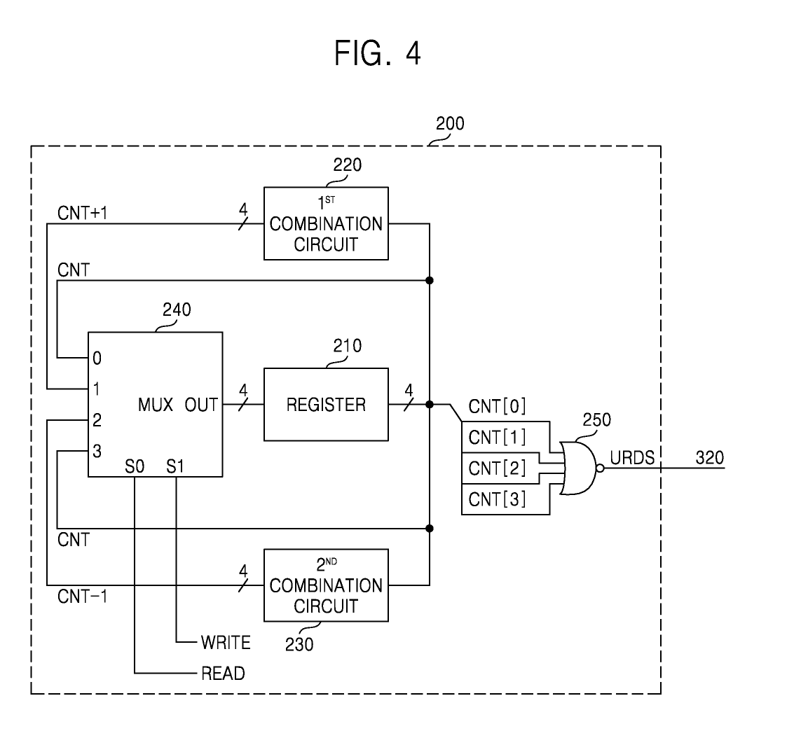

FIG. 4 shows an internal block diagram of an under-run detection circuit illustrated in FIG. 2, according to one exemplary embodiment.

Referring to FIGS. 2 to 4, an under-run detection circuit 200 includes a register 210, a first combination circuit 220, a second combination circuit 230, a multiplexer 240 and a gate circuit 250.

The register 210 stores the number of stages CNT storing data DATA1 among the plurality of stages STAGE0 to STAGE15 of the FIFO core 160 illustrated in FIG. 3.

The first combination circuit 220 supplies a value CNT+1 calculated by adding ‘1’ to the number of stages CNT stored in the register 210 to a multiplexer 240. The second combination circuit 230 supplies a value CNT−1 calculated by subtracting 1 from the number of stages stored in the register 210 to the multiplexer 240.

Here, each of the write control signal WRITE and the read control signal READ is used as each of selection signals S1 and S0 of the multiplexer 240. In detail, when the write control signal WRITE and the read control signal READ are all in a disable state, a value output from the register 210 is stored in the register 210 as it is.

When only the write control signal WRITE is enabled, the multiplexer 240 transmits a value CNT+1 output from the first combination circuit 220, i.e., a value calculated by adding 1 to a value CNT stored in the register 210, to the register 210.

When only the read control signal READ is enabled, the multiplexer 240 transmits a value output from the second combination circuit 230, i.e., a value calculated by subtracting 1 from a value CNT stored in the register 210, to the register 210. As above mentioned, one of values CNT, CNT+1, CNT−1 output from the multiplexer 240 is stored in the register 210 again. Accordingly, the register 210 inside the under-run detection circuit 200 may store the number of stages CNT storing data DATA1.

The gate circuit 250 outputs a logic high level as an under-run detection signal URDS when the number of stages CNT stored in the register 210 is 0.

When the gate circuit 250 outputs the logic high level as an under-run detection signal URDS, it means the FIFO core 160 of the FIFO circuit 120 is empty, and thus an under-run is detected.

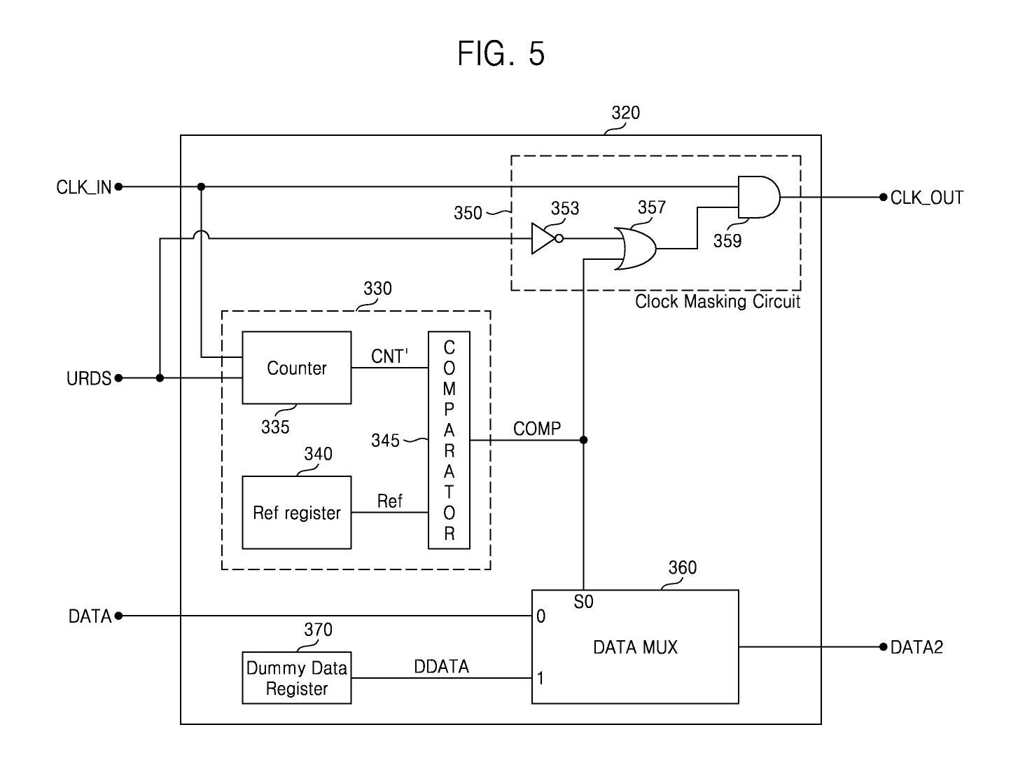

FIG. 5 shows an internal block diagram of an under-run compensation circuit illustrated in FIG. 2, according to one exemplary embodiment. Referring to FIG. 5, an under-run compensation circuit 320 includes a count comparison circuit 330, a clock masking circuit 350, a multiplexer 360, and a dummy data register 370.

In one embodiment, the count comparison circuit 330 includes a counter 335 and a comparator 345.

When an under-run detection signal URDS is a logic high level (i.e., an under-run is occurring), the counter 335 counts underflow, i.e., the number of clock signals CLK_IN supplied during time when data is not stored in the FIFO core 160, and outputs a counted value CNT′ to a comparator 345 in response to the under-run detection signal URDS output from the under-run detection circuit 200.

The comparator 345 compares a count value CNT′ output from the counter 335 with a reference value Ref and outputs a comparison value COMP. The comparator 345 outputs a comparison value COMP having a logic low level when a count value CNT′ output from the counter 335 is less than or equal to a reference value Ref, and outputs a comparison value COMP having a logic high level when the count value CNT′ output from the counter 335 is greater than the reference value Ref

For example, if a count value CNT′ output from the counter 335 is 3 and a reference value Ref is 4, the comparator 345 outputs a comparison value COMP having a logic low level.

However, when the count value CNT′ received from the counter 335 is 5 and the reference value Ref is 4, the comparator 345 outputs a comparison value COMP having a logic high level.

According to an example embodiment, a count comparison circuit 330 may further include a reference count register 340 for storing a reference value Ref.

The clock masking circuit 350 includes an inverter 353, an OR gate 357 and an AND gate 359. When an under-run detection signal URDS is a logic high level (i.e., an under-run is occurring), an inverter 353 outputs a logic low level. Accordingly, the clock masking circuit 350 determines whether to mask an input clock signal CLK_IN according to a comparison value COMP input to an OR gate 357.

That is, when the comparison value COMP is a logic low level, e.g., a count value CNT′ is less than or equal to a reference value Ref, the clock masking circuit 350 masks an input clock signal CLK_IN (e.g., an output clock signal CLK_OUT is output as a logic low regardless of CLK_IN).

When the comparison value COMP is a logic high level, e.g., a count value CNT is greater than a reference value Ref, the clock masking circuit 350 outputs an input clock signal CLK_IN as an output clock signal CLK_OUT. As such, the clock signal is masked when an under-run is occurring, but only for a certain reference number of clock signals. After the reference number of clock signals is reached, the clock signal is no longer masked.

The multiplexer 360 outputs one of data DATA and dummy data DDATA in response to a comparison value COMP output from a comparison circuit 330. That is, when a comparison value COMP is a logic low level (e.g., while the clock signal is being masked), the multiplexer 360 outputs data DATA, and when the comparison value COMP is a logic high level (e.g., while the clock signal is not being masked), the multiplexer 360 outputs dummy data DDATA. A dummy data register 370 stores dummy data DDATA supplied to the multiplexer 360.

To explain an overall operation of the under-run compensation circuit 320, when an under-run detection signal URDS is a logic high level (e.g., under-run is detected), the counter 335 counts the underflow (e.g., counts the number of consecutive clock signals for which under-run occurs) and outputs a count value CNT′ to the comparator 345.

Here, the comparator 345 compares a count value CNT′ with a reference value Ref and outputs a comparison value COMP. The comparison value COMP is supplied to the clock masking circuit 350 and the multiplexer 360. Here, the comparison value COMP is supplied as a selection signal of the multiplexer 360.

When a comparison value COMP is a logic low level (e.g., a count is less than or equal to a reference value), the clock masking circuit 350 masks an input clock signal CLK_IN and the multiplexer 360 selects and outputs data DATA. However, since there is no data DATA to be input due to occurrence of under-run, an output data DATA2 is sustained as it is output just before the occurrence of the under-run.

When a comparison value COMP is a logic high level (e.g., a count is greater than a reference value), the clock masking circuit 350 outputs an input clock signal CLK_IN as an output clock signal CLK_OUT and the multiplexer 360 outputs dummy data DDATA. When an under-run detection signal URDS is a logic low level, i.e., when under-run does not occur, the counter 335 becomes disabled, so that the comparator 345 outputs a comparison value COMP having a logic low level. Accordingly, the clock masking circuit 350 and the multiplexer 360 output an input clock signal CLK_IN and input data DATA to an output clock signal CLK_OUT and output data DATA2, respectively.

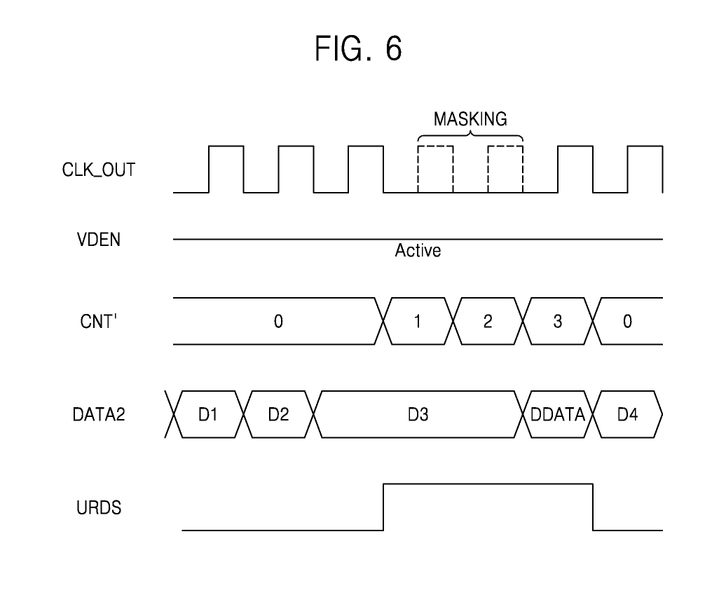

FIG. 6 shows a timing diagram for explaining an under-run compensation method according to an example embodiment. Referring to FIGS. 1 to 6, while under-run is not occurring (e.g., URDS is low), the counter 335 of the under-run compensation circuit 320 does not count up a count, so that a count value CNT′ is maintained as 0.

Here, the under-run compensation circuit 320 outputs each of input data DATA, i.e., D1, D2, and D3, and an input clock signals CLK_IN to each of an output data DATA2 and an output clock signal CLK_OUT. When an under-run occurs, the under-run detection circuit 200 senses the under-run state and transmits an under-run detection signal URDS indicating an under-run is occurring (e.g., URDS is high) to the under-run compensation circuit 320.

The counter 335 of the under-run compensation circuit 320 counts underflow, i.e., the number of clock signals CLK_IN input while the FIFO circuit 120 is empty.

When a value resulting from counting the underflow by the counter 335 is 1 or 2, i.e., when a count value CNT′ is less than or equal to a reference value of 2, the clock masking circuit 350 masks an input clock signal CLK_IN.

Here, since there is no data to be input during the occurrence of under-run, an output data DATA2 is sustained as a data D3 which was output just before the under-run occurrence.

When a value resulting from counting the underflow by the counter 335 becomes 3, i.e., when a count value CNT′ is greater than a reference value Ref, the multiplexer 360 outputs dummy data DDATA as an output data DATA2, and the clock masking circuit 350 outputs an input clock signal CLK_IN to an output clock signal CLK_OUT (e.g., the clock signal is no longer masked). When an under-run state is released, the under-run compensation circuit 320 outputs an input clock signal CLK_IN and an input data D4, and the count value CNT′ is reset to 0.

It is illustrated as an example that a reference value Ref is set to 2 in FIG. 6, however, the reference value Ref may be set to various values according to a design. Moreover, FIG. 6 only illustrates a method of masking an input clock, however, a method of masking other signals, such as a data enable signal VDEN, may be used when the count value CNT′ is less than or equal to the reference value Ref according to an example embodiment.

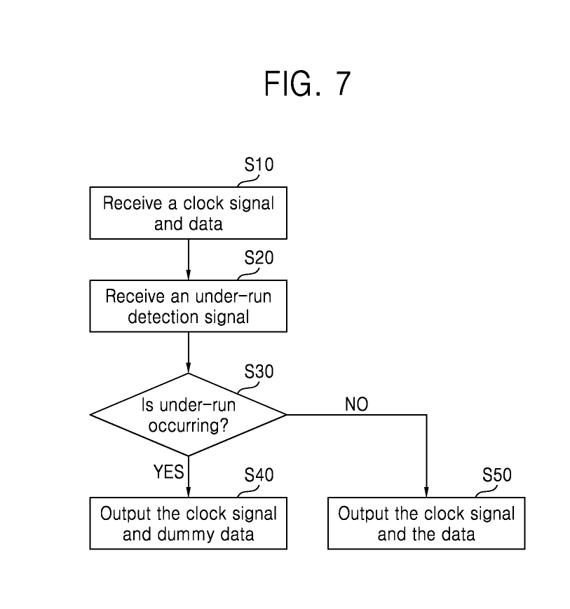

FIG. 7 is a flow chart showing a method of preventing image deterioration of a display device according to an example embodiment.

Referring to FIG. 7, an under-run compensation circuit receives a clock signal, data, and an under-run detection signal (S10 and S20). The under-run compensation circuit determines whether an under-run is occurring (S30). The under-run compensation circuit outputs the clock signal and the data (S50) when receiving an under-run detection signal that indicates that an under-run is not occurring (e.g., when the FIFO circuit 120 of FIG. 2 is not empty). On the other hand, the under-run compensation circuit outputs the clock signal and dummy data (S40) when receiving an under-run detection signal that indicates that an under-run is occurring (e.g., when the FIFO circuit 120 of FIG. 2 is empty). In detail, when receiving the under-run detection signal that indicates that an under-run is occurring, a counter in the under-run compensation circuit counts the clock signal to determine a count value. For example, the counter 335 of the under-run compensation circuit 320 counts underflow, i.e., the number of clock signal CLK_IN input while the FIFO circuit 120 is empty in FIG. 5. A comparator in the under-run compensation circuit compares the counter value with a reference count value. For example, the comparator 345 compares a count value CNT with a reference value Ref and outputs a comparison value COMP in FIG. 5. Consequently, the clock signal is masked and the data are output when the count value is less than or equal to a reference count value and the clock signal and dummy data are output when the count value is greater than the reference count value.

An under-run compensation circuit according to the example embodiments, an under-run compensation method, and apparatuses having the under-run compensation circuit may prevent image deterioration of a display device by detecting and compensating an under-run state of an input/output buffer.

Although various embodiments of the present disclosure have been shown and described, it will be appreciated by those skilled in the art that changes may be made in these embodiments without departing from the principles and spirit of the general inventive concept, the scope of which is defined in the appended claims and their equivalents.

What is claimed is:

1. An under-run compensation circuit configured to:
receive a clock signal;
receive data;
receive an under-run detection signal that indicates whether or not an under-run is occurring;
output the clock signal and the data when receiving an under-run detection signal that indicates that an under-run is not occurring;
output the clock signal and dummy data when receiving an under-run detection signal that indicates that an under-run is occurring.

2. The under-run compensation circuit of claim 1, further configured to, when receiving the under-run detection signal that indicates that an under-run is occurring:
mask the clock signal when a count value counting underflow is less than or equal to a reference count value; and
output the clock signal and the dummy data when the count value is greater than the reference count value.

3. The under-run compensation circuit of claim 1 further comprising:
a count comparison circuit configured to compare a count value counting underflow with a reference count value in response to the under-run detection signal that indicates that an under-run is occurring and generate a comparison signal according to a comparison result;
a clock masking circuit configured to mask the clock signal according to the comparison signal; and
a data selection circuit configured to output one of the data and the dummy data according to the comparison signal.

4. The under-run compensation circuit of claim 3, wherein the count comparison circuit comprises:
a counter for counting the underflow; and
a comparator for generating the comparison signal which is a result of comparing the count value with the reference count value.

5. A display controller comprising:
a display interface including the under-run compensation circuit of claim 1;
a direct memory access (DMA) circuit including a first-in-first-out (FIFO) circuit and configured to transmit the data to the under-run compensation circuit through the FIFO circuit; and
an under-run detection circuit configured to determine an under-run state of the FIFO circuit, and based on the determination, transmit the under-run detection signal to the under-run compensation circuit.

6. The display controller of claim 5, wherein the under-run compensation circuit is configured to:
count underflow when receiving the under-run detection signal that indicates an under-run is occurring,
mask the clock signal when a count value counting the underflow is less than or equal to a reference count value, and
output the clock signal and the dummy data when the count value is greater than the reference count value.

7. The display controller of claim 5, wherein the under-run compensation circuit comprises:
a count comparison circuit configured to generate a comparison signal according to a result of comparing a count value counting underflow with a reference count value in response to the under-run detection signal that indicates that an under-run is occurring;
a clock masking circuit configured to mask the clock signal according to the comparison signal received from the count comparison circuit; and
a data selection circuit configured to output one of the data and the dummy data according to the comparison signal output from the count comparison circuit.

8. The display controller of claim 7, wherein the count comparison circuit comprises:
a counter for counting the underflow; and
a comparator for generating the comparison signal as a result of comparing the count value with the reference count value.

9. A display system including the under-run compensation circuit of claim 1, and further comprising:
a display; and
a display controller for controlling the display,
wherein the display controller comprises the under-run compensation circuit.

10. The display system of claim 9, wherein the under-run compensation circuit is further configured to, when receiving the under-run detection signal that indicates that an under-run is occurring:
mask the clock signal when a count value counting the underflow is less than or equal to a reference count value, and
output the clock signal and the dummy data when the count value is greater than the reference count value.

11. The display system of claim 9, wherein the under-run compensation circuit comprises:
a count comparison circuit configured to generate a comparison signal according to a result of comparing a count value counting underflow with a reference count value in response to the under-run detection signal that indicates that an under-run is occurring;
a clock masking circuit configured to mask the clock signal according to the comparison signal output from the count comparison circuit; and
a data selection circuit configured to output one of the data and the dummy data according to the comparison signal output from the count comparison circuit.

12. The display system of claim 11, wherein the count comparison circuit comprises:
a counter for counting the underflow; and
a comparator for generating the comparison signal according to a result of comparing a count value counting the underflow with the reference count value.

13. A display controller for preventing image deterioration of a display device, the display controller comprising:
an under-run compensation circuit configured to:
receive a clock signal;
receive data; and
output the clock signal and dummy data based on a count value for the clock signal, when an under-run detection signal indicates that an under-run is occurring.

14. The display controller of claim 13, wherein the under-run compensation circuit is further configured to, when receiving the under-run detection signal that indicates that an under-run is occurring:
mask the clock signal when the count value is less than or equal to a reference count value, and
output the clock signal and the dummy data when the count value is greater than the reference count value.

15. The display controller of claim 13, wherein the dummy data is generated by a dummy data register.

16. A display system comprising:
a display; and
the display controller of claim 13.

17. A method of preventing image deterioration of a display device, the method comprising:
receiving a clock signal and data;
receiving an under-run detection signal that indicates whether or not an under-run is occurring;
outputting the clock signal and the data when receiving an under-run detection signal that indicates that an under-run is not occurring; and
outputting the clock signal and dummy data when receiving an under-run detection signal that indicates that an under-run is occurring.

18. The method of claim 17, further comprising:
counting the clock signal when the under-run detection signal indicates that an under-run is occurring, to determine a count value; and
comparing the count value with a reference count value,
wherein outputting the clock signal and dummy data comprises:
masking the clock signal and outputting the data when the count value is less than or equal to a reference count value; and
outputting the clock signal and dummy data when the count value is greater than the reference count value.

19. The method of claim 18, wherein outputting the dummy data comprises generating the dummy data by a dummy data register.

20. The method of claim 17, wherein the under-run detection signal indicates that an under-run is occurring when a FIFO circuit for receiving the data is empty.
